(19) United States
(12) Patent Application Publication
(10) Pub. No.: US 2002/0013882 A1
(43) Pub. Date: Jan. 31, 2002

(54) Recordable optical disc and apparatus therefor including operating system and user configuration

(76) Inventors: Jung -wan Ko, Yongin-si (KR); Byung-jun Kim, Suwon-si (KR)

Correspondence Address: STAAS & HALSEY LLP, 700 11TH STREET, NW, SUITE 500, WASHINGTON, DC, 20001, US

(21) Appl. No.: 09/861,889

(22) Filed: May 22, 2001

(30) Foreign Application Priority Data
May 22, 2000 (KR) 2000-27499

(51) Int. Cl. G06F 13/00

(52) U.S. Cl. 711/111

(57) ABSTRACT

A recordable optical disc containing various operating systems and user configurations and an apparatus reading from and recording onto the same are provided. The optical disc has a system region in which data is read by a computer and a user cannot record data therein, and a data region in which data can be recorded, in which at least one operating system and information thereof are recorded in the system region, and user configuration setting information having configuration variables of users is recorded in the data region. The optical disc records various operating systems, application programs and user configurations so that multiple users can use various types of computers or game systems.

### CROSS REFERENCE TO RELATED APPLICATION

This application claims the benefit of Korean Patent Application No. 00-27499, filed May 22, 2000, in the Korean Industrial Property Office, the disclosure of which is incorporated herein by reference.

### BACKGROUND OF THE INVENTION

1. Field of the Invention

The present invention relates to a recordable optical disc and to an apparatus reading from and recording onto the optical disc, and more particularly, to a recordable optical disc containing various operating systems and user configurations, and an apparatus reading from and recording on the same.

2. Description of the Related Art

When a user desires to use an operating system and a computer or game system using the operating system, various preliminary steps (installing a program and setting configurations) are required. However, data contained in this operating system cannot be used in a computer or game system having different configurations, or if they can, this data requires additional preliminary steps in order to make it compatible with systems having different configurations.

The operation of the conventional computer or game system is as follows:

(1) For a computer, a user installs one operating system in his computer and creates data using required programs.

(2) For a game system, a user buys dedicated game software and uses the game system.

In the case of step (1) above, there are various kinds of computers, including an IBM PC, an Apple Mac, a Unix Machine (HP, SUN, etc.), etc. There are also various kinds of operating systems, including MS series (Windows, Windows NT, etc.), Unix series (HP-UX, Solaris, etc.), Linux series (RedHad, FreeBSD, etc.), OS/2, BeOS, etc. There are more various kinds of program products for each operating system. Data created in the various environments are indescribably abundant. In some cases, different types of data can be processed within one system, but in most cases, different types of data cannot be processed within one system due to limitations such as different operating systems, different program languages, or because of a media which is not supported, or because of lack of a program which is supported.

In some cases, different types of data can be processed in one system, but require preliminary steps to be performed again because of different user configurations. In these cases, a job which usually takes just several minutes ends up taking much longer. This problem results in other problems passed on to the manufacturers. Particularly, companies which develop and produce operating systems and programs have to develop and produce each operating system and program for a corresponding computer system, which causes overlaps. In addition, consumers have to buy each operating system and program to coincide with each other.

As for game systems, a media which a game system does not support cannot be operated at all in the game system. Even if there is a media which the game system supports, a different version of the program may not be executable on the game system. If a user changes a game system being used to another game system, all types of already purchased software becomes useless if it is not executable on the new system. The user ] then is required to purchase or create media that can be supported by the new game system. Since software developers have to repeatedly develop and sell software for each game system on the market, development costs and losses in sales and distribution increase.

### SUMMARY OF THE INVENTION

Accordingly, it is an object of the present invention to provide an optical disc which can be used in an apparatus supporting the optical disc regardless of the types of machines and apparatuses used, after recording operating systems and user configurations on to the disc.

It is another object of the present invention to provide an apparatus appropriate for working together with the optical disc disclosed above.

Additional objects and advantages of the invention will be set forth in part in the description which follows, and, in part, will be obvious from the description, or may be learned by practice of the invention.

The foregoing objects of the present invention are achieved by providing an optical disc having a system region in which data is read by a computer and in which a user cannot record data therein, and in which at least one operating system and information thereof are recorded therein; and a data region in which data can be recorded therein, and user configuration setting information, having configuration variables of users who use the computer, can be recorded therein.

The above objects of the present invention may also be achieved by providing a computer that supports an optical disc containing several computer operating systems, the computer having a central processing unit (CPU); a random-access-memory (RAM), storing a boot program and a selected operating system controlling the CPU; an optical disc player reading the selected operating system from the optical disc; a boot program storage device storing a boot program which controls the booting operation of the computer and contains at least a driver of the optical disc player and a loader program controlling the optical disc player to read a selected operating system from the optical disc and loading the operating system on the RAM; and a linker having information on the location in which the boot program is recorded, reading the boot program from the boot program storage device, referring to the location information, and loading the boot program on the RAM.

The above objects of the present invention may also be achieved by providing a plurality of operating systems recorded on an optical disc, the computer having an input device for receiving a user's input, and the boot program receiving externally a selection input selecting one of the operating systems recorded on the optical disc reading the selected operating system from the optical disc, and loading the operating system on the RAM.

It is another aspect of the invention that user configuration setting information containing configuration variables used by the user is recorded on the optical disc, and that the operating system loads the application program used by the user and referring to the user configuration setting information onto the computer.

### BRIEF DESCRIPTION OF THE DRAWINGS

These and other objects and advantages of the present invention will become more apparent and more readily appreciated from the following description of the preferred embodiments thereof with reference to the attached drawings in which:

FIG. 1 illustrates the structure of an optical disc according to the present invention;

FIG. 2 is a block diagram of the structure of an apparatus according to the present invention;

FIG. 3 is a flowchart of a booting operation of the apparatus of FIG. 2;

FIG. 4 is a schematic diagram of the operation of a linker of FIG. 2;

FIG. 5 is a schematic diagram of a process storing user configuration settings in the apparatus of FIG. 2;

FIG. 6 illustrates an example in which multiple users use the apparatus of FIG. 2, using the user configuration setting of FIG. 5; and

FIG. 7 illustrates a case in which the optical disc of FIG. 1 is applied to a game system.

### DESCRIPTION OF THE PREFERRED EMBODIMENTS

Reference will now be made in detail to the embodiments of the present invention, examples of which are illustrated in the accompanying drawings, wherein like reference numerals refer to like elements throughout. The embodiments are described below in order to explain the present invention by referring to the figures.

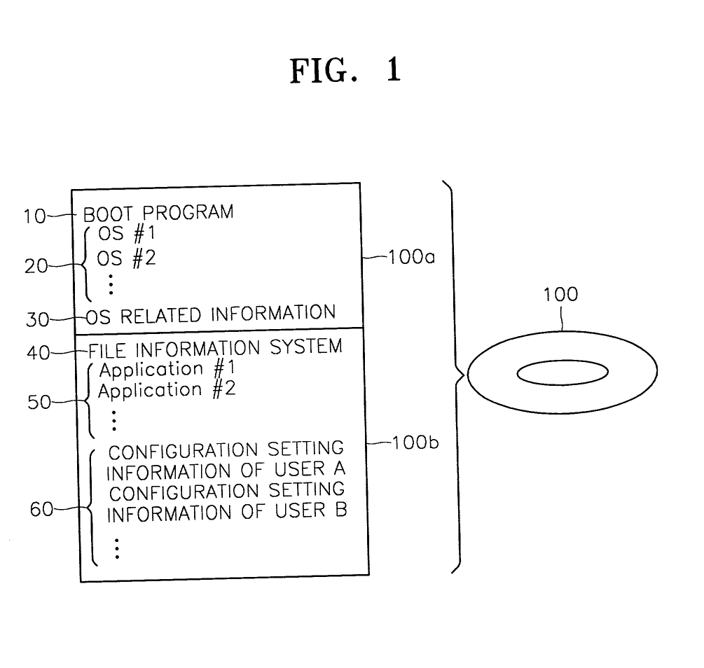

FIG. 1 shows the structure of an optical disc according to the present invention. As shown in FIG. 1, the optical disc 100 has a system region 100a and a data region 100b. A user cannot write data in the system region 100a but can write data in the data region 100b. In the system region 100a, a boot program 10, operating systems 20, and operating systemrelated information 30 are recorded. In the data region 100b, file system information 40, programs 50, and user configuration information 60 are recorded.

Since a plurality of operating systems 20 and a plurality of programs 50 read by a computer and which manage the operation of the computer are recorded on the optical disc shown in FIG. 1, the optical disc can be used appropriately depending on user configurations.

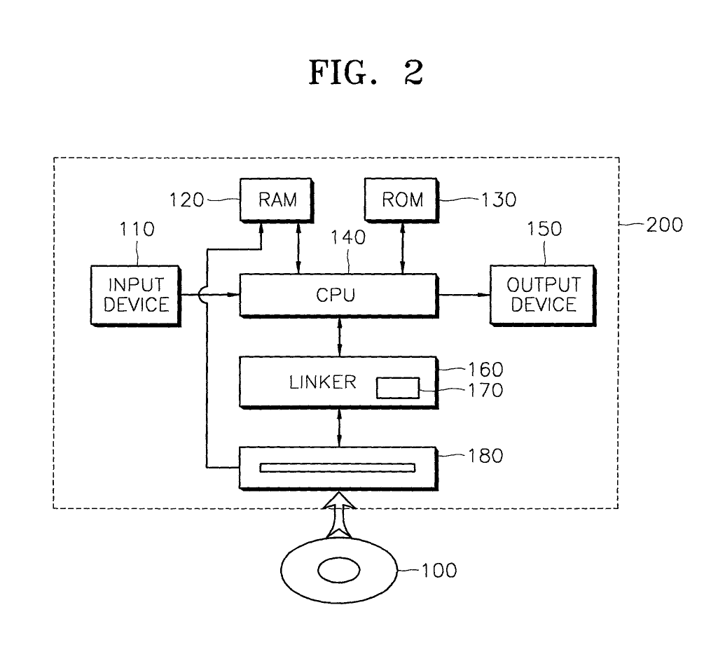

FIG. 2 is a block diagram of the structure of an apparatus according to the present invention. The apparatus of FIG. 2 has an input device 110, a RAM 120, a ROM 130, a CPU 140, an output device 150, a linker 160, a boot program storage device 170, and an optical disc player 180. Here, the optical disc player 180 reproduces data from and records data on an optical disc 100, and corresponds with a boot device 170 as disclosed above in the summary section of the present invention.

The input device 110 receives signals for selection, commands, data, etc. This received information can be provided by a user or by any external method, and can be implemented by a keyboard, a mouse, etc. The RAM 120 stores a program controlling the operation of the CPU 140 and data used in the program.

The output device 150 displays the processing results of the computer 200, and can be implemented by a monitor, a printer, etc.

The linker 160 checks the system configuration of the computer and loads the operating system stored on the optical disc 100 into the computer 200 when the computer is booted. Referring to location information of a boot program, which is internally stored, the linker 160 reads the boot program stored in the boot program storage device 170 and loads the boot program into the RAM 120.

The boot program includes a priority table, a driver controlling the optical disc player 180, and a loader program which controls the optical disc player 180 to read an operating system from the optical disc 100 and load the operating system into the RAM 120. Recorded on the optical disc 100 is at least the boot program, file system information and operating system information .

If the boot program can be executed in a plurality of boot devices, this information is displayed to the user. Then, a selected operating system is fetched from the selected boot device among the plurality of boot devices and loaded on the RAM 120.

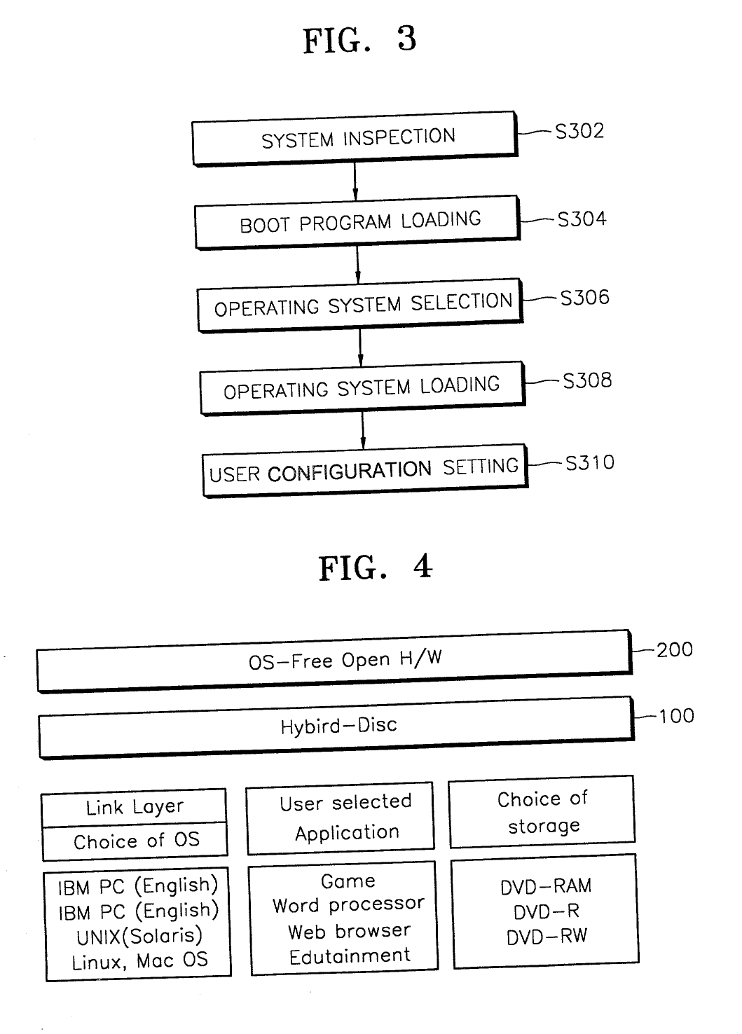

FIG. 3 is a flowchart of a booting operation of the apparatus of FIG. 2. First, the computer is turned on, and then the linker 160 checks the system configuration during the operation S302. The linker 160 checks the installation states and problems of various peripheral devices connected to the computer, such as a mouse, keyboard, monitor, graphic card, printer, speaker, game system, audio system, power management system, floppy disc controller, hard disc controller, etc., and generates a list (hardware list) containing these devices. If there is a problem during this process, the linker 160 indicates an error to the user and stops the operation. If there is no problem during this process, the next process, which is a boot program loading operation, is performed. For example, if the keyboard is not installed or has a problem, the linker 160 displays a keyboard error and stops the operation.

From the boot program loading operation S304 on, the operations of this embodiment of the invention are different from those of an ordinary personal computer. For example, first, the boot program is stored inside the boot program storage device 170, then, the linker 160 reads the boot program and loads the program on the RAM 120. The boot program is stored inside the linker 160 is used. Here, the boot program can be stored in the ROM 130, the hard disc, etc. But the linker 160 should know the location of the boot program and be able to access the boot program when required. This boot program contains a priority table, an optical disc player driver, and a loader program. At a predetermined location on the optical disc 100, which is accessed using the optical disc player driver, the boot sector location, information on a file system, and information on the operating system are described.

According to the indication by the loader program, the user selects an operating system during the operation S306. After the computer 200 confirms that the file system obtained by the optical disc 100 is supported, the computer 200 informs the user of data collected from one or a plurality of boot devices and optical discs, and requests the user to select one operating system 20 from several provided. If only one operating system is recorded on the disc, this operating system is automatically selected for use with the computer.

If the user selects one optical disc of several and an operating system recorded on the disc, the selected operating system 20 is read from the optical disc 100 and loaded into the RAM 120 during the operation S308. Here, the boot program passes the hardware list generated in the system checking operation S302 to the operating system. Based on this list, the operating system finds and installs a driver file necessary to each device on the list.

After the operating system is loaded, a necessary user configuration is set up using user configuration setting information recorded in the data region 100b disc 100 during the operation S310. After obtaining configuration variables, such as application programs used by the user and data files generated by the application programs from the user configuration setting information 60, necessary application programs are executed. For example, whatever configuration a computer may have, the user can obtain the same operating system and user configuration and update the user configuration appropriately in response to changes. The user configuration setting information contains information on the application program used by the user and data files generated using the application programs.

FIG. 4 is a schematic diagram of the operation of a linker of FIG. 2. In FIG. 4, various operating systems and application programs are recorded on the optical disc 100, which is operated in the computer 200 by way of the disk player 180, as illustrated in FIG. 2. The linker 160 selects one among various operating systems provided, for example, IBM PC (Korean), IBM PC (English), UNIX (Solaris), Linux, Mac Os, etc., and loads the selected operating system into the computer 200. Applications programs selected by the user, for example, game programs, word processors, web browsers, and edutainment (a coined word of education and entertainment), are executed by the loaded operating system. Meanwhile, the user selects one among various boot devices, for example, a DVD-RAM player, a DVD-R player, and a DVD-RW player, etc. Then, data is reproduced from and recorded on the optical disc 100 by the selected boot device.

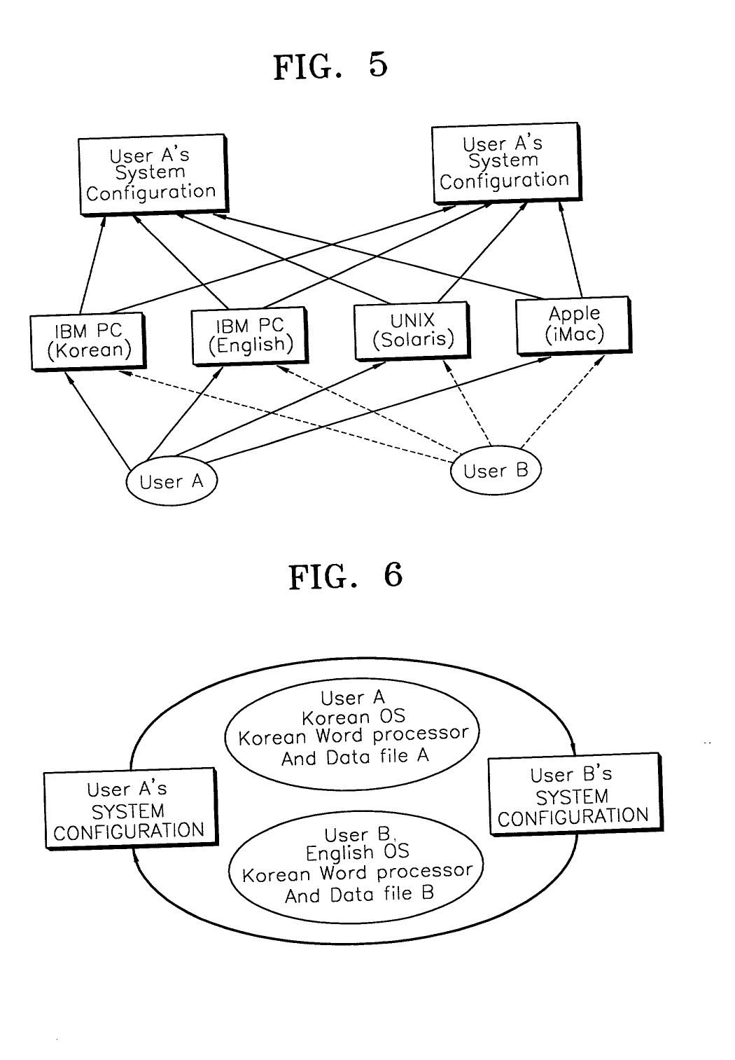

FIG. 5 is a schematic diagram of a process storing user configuration settings in the apparatus of FIG. 2. The user can use the optical disc 100 shown in FIG. 1 with various platforms and operating systems, while information on the kinds of application programs used by the user and data files generated by the application programs are recorded in the user configuration setting information. Therefore, if the user has only the optical disc 100 of the present invention, the user can do his or her job on any computer available having any operating systems.

FIG. 6 shows an example in which multiple users use the apparatus of FIG. 2 while employing the user configuration settings of FIG. 5. With the configuration illustrated in FIG. 6, a user A uses a Korean operating system and a Korean word processor, and has data file A generated by the Korean word processor. These configuration variables are recorded in the data region 100b of user A's system configuration optical disc 100. Meanwhile, a user B uses an English operating system, an English word processor, and has data file B generated by the English word processor. These configuration variables are recorded in the data region 100b of user B's system configuration optical disc 100. In using the apparatus of FIG. 2, user A can do his or her job using user A's system configuration, and likewise, user B can do his or her job using user B's system configuration. Therefore, each of various users can use a common disc for doing his or her own job. Likewise, by using the apparatus of FIG. 2, various users are able to do their jobs without the requirement of setting individual configurations.

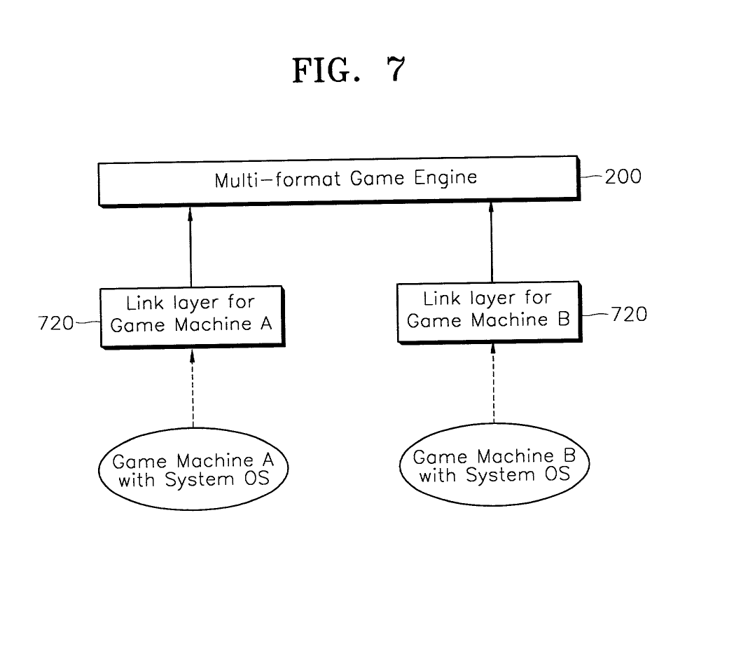

FIG. 7 illustrates a case in which the optical disc of FIG. 1 is applied to a game system. The game engine 710 of the game system can have various formats. Similarly to the linker 160 of the apparatus of FIG. 2, a linker 720 loads an appropriate operating system and game programs to the game engine 710 so that various game systems can operate with only one optical disc.

As described above, the optical disc according to the present invention records various operating systems, application programs and user configurations so that multiple users can use various types of computers or game systems without the need to purchase additional software.

The apparatus according to the present invention has an optical disc player for reproducing an optical disc, which supports an open structure and various operating systems, and therefore multiple users can easily use various operating systems.

Although a few preferred embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An optical disc comprising:
a system region in which data is read by a computer and a user cannot record data; and
a data region in which data can be recorded,
wherein at least one operating system and information thereof are recorded in the system region and user configuration setting information having configuration variables of users, who use the computer, is recorded in the data region.

2. The optical disc of claim 1, wherein the user configuration setting information includes information on the types of application programs, which the user used on the operating system, and data files generated by the application programs.

3. A computer supporting an optical disc containing computer operating systems, the computer comprising:
a central processing unit (CPU);
a random-access-memory (RAM) storing a boot program and operating system controlling the CPU;
an optical disc player reading the operating system from the optical disc;
a boot program storage medium storing a boot program which controls the booting operation of the computer and contains at least a driver of the optical disc player and a loader program controlling the optical disc player to read the operating system and load the operating system on the RAM; and
a linker having information on the location in which the boot program is recorded, reading the boot program from the boot program storage medium, referring to the location information, and loading the boot program on the RAM.

4. The computer of claim 3, wherein a plurality of operating systems are recorded on the optical disc, the computer has an input device for receiving user's input, and the boot program receives a selection input selecting one of several operating systems recorded on the optical disc by the user, reads the selected operating system from the optical disc and loads the operating system on the RAM.

5. The optical disc of claim 2, wherein user configuration setting information containing configuration variables used by the user is recorded on the optical disc, and the operating system loads the application program used by the user, to the computer, referring to the user configuration setting information.

6. An optical disc comprising:
a read only system region having at least one operating system recorded therein; and
a data region wherein user configuration setting information can be read from and written into.
